(19) United States
(12) Patent Application Publication
(10) Pub. No.: US 2026/0244187 A1
(43) Pub. Date: Aug. 20, 2026

(54) DISPLAY OF ROBOT'S INTENDED ACTIONS ON HMI ELEMENTS FOR VISIBILITY TO TRAFFIC USERS

(71) Applicant: ATLAS ROBOTICS AND AUTOMATION, INC., Pittsburgh, PA (US)

(72) Inventors: Çetin Alp Meriçli, Pittsburgh, PA (US); Tekin Alp Meriçli, Pittsburgh, PA (US)

(21) Appl. No.: 19/462,245

(22) Filed: Jan. 28, 2026

Related U.S. Application Data
(60) Provisional application No. 63/751,075, filed on Jan. 29, 2025.

(51) Int. Cl. G05B 19/409; G05B 19/4155

(52) U.S. Cl. CPC G05B 19/409; G05B 19/4155; G05B 2219/40519

(57) ABSTRACT

An autonomous mobile robot's intended actions are displayed to nearby traffic users, integrating navigation trajectory data with environmental perception to generate context-adaptive intent visualizations. HMI output devices such as displays, lights, and projection systems adapt visualization parameters (size, brightness, detail level, color profile, animation) based on robot velocity, proximity to detected humans, ambient lighting, and urgency. Color profiles dynamically transition from green tones at safe distances to amber/yellow at moderate proximity to red at close proximity to detected humans. Projected graphics show one or more of intended paths, directional arrows, safety zones, warnings, and destination information on ground surfaces, or destination identifiers (e.g., aisle locations, bay numbers, dock identifiers), enabling traffic users relevance of the robot's path. Multi-modal synchronization coordinates projections, displays, lights, and audio. Applications include warehouse autonomous mobile robots, autonomous forklifts, and autonomous vehicles communicating intentions to humans in shared environments, enhancing safety and operational efficiency.

### CROSS REFERENCE TO RELATED APPLICATIONS

This application claims priority to U.S. Provisional Patent Application No. 63/751,075, filed Jan. 29, 2025, entitled “DISPLAY OF ROBOT'S INTENDED ACTIONS ON HMI ELEMENTS FOR VISIBILITY TO TRAFFIC USERS,” the entire contents of which are incorporated herein by reference.

### TECHNICAL FIELD

The present disclosure relates generally to autonomous systems and robotics, and more particularly to methods, systems, and apparatus for displaying a robot's intended actions on Human-Machine Interface (HMI) elements to enhance the visibility and predictability of robot movements to other road or pathway users from a safe distance in shared environments.

### BACKGROUND

As autonomous mobile robots (AMRs), autonomous vehicles (AVs), industrial robots, and other intelligent machines increasingly operate in environments shared with humans, the need for clear communication of robot intentions has become critical. Human workers, pedestrians, vehicle operators, and other traffic participants sharing operational spaces with autonomous systems need to understand what these machines intend to do in order to coordinate their own movements safely and efficiently.

### DESCRIPTION OF RELATED ART

Traditional human-machine interfaces (HMIs) for mobile robots and autonomous vehicles typically include indicator lights, simple displays, and basic visual elements that communicate current status but provide limited or no indication of intended future actions. This creates safety risks and operational inefficiencies in shared environments.

### Limitations of Existing Systems

Current approaches to robot and vehicle signaling face several significant limitations:
Reactive vs. Predictive Information: Conventional HMIs show current state (e.g., “robot is moving,” “vehicle is stopped”) but not intended future actions (e.g., “robot will turn left in 3 seconds,” “vehicle intends to yield”). Humans must observe robot behavior over time to infer intentions, creating delays and uncertainty.
Limited Visibility Range: Standard LED indicator lights and small display screens are only visible at close range (typically 5-15 meters under good conditions). In large warehouse environments or outdoor settings, humans cannot see these indicators until dangerously close to the robot.
Abstract Symbolism: Traditional displays use abstract symbols (lights, icons, text) that require cognitive translation to understand spatial implications. A human seeing “TURN LEFT” text must mentally project this onto the environment to understand where the robot will go.
Fixed Mounting Limitations: HMI elements mounted on robot chassis have fixed positions and viewing angles, creating blind spots. A display on the front of a robot is invisible to humans approaching from behind.
Inadequate Dynamic Range: LED-based displays have limited brightness range and poor visibility in high ambient light conditions such as bright warehouses or outdoor daylight.
Static Presentation: Most HMI systems show static information that doesn't adapt based on robot speed, proximity to humans, or urgency level.

Several prior art references address various aspects of vehicle and robot communication:
U.S. Pat. No. 9,475,422 to Hillis et al. (Applied Invention LLC, Oct. 25, 2016) describes “Communication between autonomous vehicle and external observers” enabling vehicles to dynamically adjust external displays based on environmental context, detected objects, and viewing conditions. The system determines what information should be displayed to external viewers (pedestrians, other vehicles) and adapts display parameters including content, brightness, size, and position based on viewer location, ambient lighting, and urgency. This is highly relevant to the disclosed application's context-adaptive rendering that adjusts HMI output parameters based on robot speed, proximity to detected humans, ambient lighting, and urgency level.
U.S. Pat. No. 12,365,570 to Ulbrich et al. (METRALABS NEUE TECHNOLOGIEN und SYSTEME GmbH, Jul. 22, 2025) describes “Autonomous industrial truck” with communication systems for autonomous industrial vehicles operating in warehouse environments, including external displays and indicators for communicating operational status and intended maneuvers to nearby workers. The system addresses safe human-robot interaction in shared industrial spaces through visual communication of vehicle intentions. This relates directly to the disclosed application's focus on warehouse AMR and autonomous forklift applications displaying intentions to human workers.
U.S. Pat. No. 8,954,252 to Urmson et al. (Waymo LLC, Feb. 10, 2015) describes “Pedestrian Notifications” enabling autonomous vehicles to communicate intended actions directly to pedestrians through external displays and audio outputs. The system detects pedestrians via sensors, determines crossing likelihood, and automatically displays notifications such as “safe to cross” or stop signals on electronic displays. This is directly relevant to displaying robot intentions to traffic users through HMI elements for predictive communication and safety, though it does not describe projection-based path visualization or sophisticated adaptive rendering.
U.S. Pat. No. 9,804,599 to Kentley-Klay et al. (Zoox Inc, Oct. 31, 2017) describes “Active Lighting Control for Communicating a State of an Autonomous Vehicle” using active lighting patterns that alert pedestrians and other road users of operational state. The technology integrates perception, planning, and exterior safety components to intelligently activate light emitters based on detected objects and predicted collision scenarios. It is relevant to the disclosed application's use of indicator lights and adaptive HMI rendering based on environmental context and detected humans.
U.S. Pat. No. 10,160,378 to Sweeney et al. (Aurora Operations Inc, Dec. 25, 2018) describes a “Light Output System for a Self-Driving Vehicle” using visual outputs including colored LED displays and projected images to signal whether an autonomous vehicle will proceed or yield. The system features a lighting strip conveying movement information through dynamic patterns, colors, and brightness changes reflecting anticipated actions like acceleration, turning, or lane changes before they occur. This relates directly to projection-based intent display and multi-modal synchronized communication.
U.S. Pat. No. 9,421,909 to Strickland et al. (Honda Motor Co Ltd, Au. 23, 2016) describes a “Vehicle to Pedestrian Communication System and Method” enabling wireless communication between vehicles and pedestrians to exchange safety information. The system can classify different pedestrian types and tailor alerts accordingly, allowing vehicles to adjust responses based on detected collision risks and pedestrian characteristics. While focused on wireless V2P communication rather than visual displays, it addresses the same problem of communicating vehicle intentions to pedestrians for safety.
U.S. Pat. No. 11,148,661 to Golgiri et al. (Ford Global Technologies LLC, Oct. 19, 2021) describes “Mobile Device Tethering for a Remote Parking Assist System” incorporating projector lamps that create visual boundary representations on the ground, projecting visible boundary lines with multi-color capability and variable luminosity for different lighting conditions. While designed for remote parking assistance, it demonstrates ground projection for communicating spatial information and boundaries, directly relevant to the disclosed application's projection-based path trajectory and safety zone displays.
U.S. Pat. No. 11,396,271 to Kourous-Harrigan (Ford Global Technologies LLC, Jul. 26, 2022) describes “System and Method for Communicating between Autonomous Vehicle and Vulnerable Road Users” enabling AVs to warn pedestrians via augmented reality overlays on their mobile devices. The AV broadcasts navigational trajectory and intended path, which mobile devices receive and display as AR visualizations including directional arrows, warning messages, and color-coded indicators. While using AR on mobile devices rather than vehicle-mounted displays, it addresses trajectory visualization and intent communication to traffic users.
U.S. Pat. No. 9,517,767 to Kentley et al. (Zoox Inc, Dec. 13, 2016) describes “Internal Safety Systems for Robotic Vehicles” that detect potential collision threats and automatically activate protective measures including exterior alerts such as acoustic signals and visual warnings. While primarily focused on internal safety systems, it includes external warning displays and sound outputs to communicate with nearby entities about detected hazards, relevant to the disclosed application's warning visualization and multi-modal communication.

None of these references describe or suggest a comprehensive system that integrates data from navigation and motion planning systems with environmental perception to generate real-time, context-adaptive visualizations of robot intended actions displayed on HMI elements (including displays, lights, and projection systems) in a manner optimized for visibility, comprehensibility, and safety in diverse operating conditions.

### Problems Addressed

The present disclosure addresses several critical problems in human-robot interaction for shared environments:
Insufficient Predictive Information: Enabling humans to anticipate robot actions before they occur, providing time for appropriate responses.
Limited Visibility: Ensuring robot intentions are visible from sufficient distances for safe interaction, including in bright ambient lighting and at various approach angles.
Spatial Ambiguity: Eliminating ambiguity about where the robot intends to travel by showing intended paths, trajectories, and occupied spaces.
Context Inflexibility: Adapting HMI output based on robot speed, proximity to humans, environmental conditions, and urgency to optimize communication effectiveness.
Cognitive Load: Reducing the mental effort required for humans to understand robot intentions through intuitive, spatial visualizations.

### SUMMARY

Existing HMI systems for autonomous robots and vehicles are inadequate for safe, efficient operation in shared human-robot environments because they:—Fail to provide predictive information about intended actions—Lack sufficient visibility range and brightness—Do not adapt to changing contexts (speed, proximity, lighting)—Provide abstract information requiring cognitive translation rather than intuitive spatial visualization—Have limited coverage angles and blind spots

There is a significant need for improved HMI systems that overcome these limitations.

The present disclosure provides systems, methods, and apparatus for displaying a robot's intended actions on Human-Machine Interface (HMI) elements in a manner that is visible, comprehensible, and useful to other traffic users (humans, vehicles, other robots) sharing the robot's operational environment.

In one embodiment, a system for displaying robot intentions comprises: one or more processors executing navigation and motion planning software that generates trajectory data representing the robot's intended path; one or more HMI output devices including at least one device selected from the group consisting of display screens, indicator lights, and projection systems; one or more sensors for environmental perception; and an HMI controller that receives the trajectory data, receives environmental context from the sensors, generates intent visualizations based on the trajectory data and environmental context, and controls the HMI output devices to display the intent visualizations in a manner adapted to current operating conditions.

The intent visualizations may include: directional arrows indicating intended travel direction; path trajectory representations showing the spatial route the robot will follow; color-coded safety zones indicating areas around the robot that humans should avoid or approach cautiously; warning symbols and pictographs; speed and status information; and dynamic graphics that change based on robot state and environment.

In another embodiment, the HMI system includes projection systems that project visual information onto environmental surfaces (e.g., ground, walls, floors) adjacent to the robot, creating spatially-contextual visualizations that show where the robot will travel, where hazards exist, or where safe interaction areas are located.

In another embodiment, the HMI controller implements context-adaptive rendering that dynamically adjusts HMI output parameters including: size and scale of graphics based on robot speed; brightness and contrast based on ambient lighting; level of detail based on proximity to detected humans; color schemes based on proximity to detected humans (transitioning from green tones at safe distances to amber/yellow at moderate proximity to red at close proximity), surface properties, and urgency; and animation styles based on attention requirements.

In another embodiment, multiple HMI output devices are coordinated to provide omnidirectional visibility and multimodal communication. For example, displays, lights, projectors, and audio outputs may be synchronized to present consistent intent information through multiple channels.

In another embodiment, the system detects humans in the environment using cameras, LIDAR, or other sensors, and adapts HMI output based on human positions, including directing displays toward detected humans, adjusting detail level based on distance to humans, and modifying warnings based on potential interaction risks.

The disclosed systems provide numerous advantages over prior art:
Predictive Communication: Showing intended future actions before they occur, enabling proactive human responses
Long-Range Visibility: HMI elements visible at extended distances enabling adequate reaction time for traffic users
Spatial Clarity: Projecting information onto the environment where actions will occur, eliminating ambiguity
Context Adaptation: Real-time adjustment of HMI output to suit current conditions, robot state, and human proximity
Intuitive Understanding: Visual presentations that are immediately comprehensible without training or cognitive translation
Comprehensive Coverage: 360-degree visibility through multi-element HMI arrays
Multimodal Reinforcement: Coordinated visual, auditory, and graphical communication enhancing information retention

These and other features and advantages of the present disclosure will become apparent from the following detailed description and appended claims.

### BRIEF DESCRIPTION OF THE DRAWINGS

FIG. 1 depicts a system architecture for an autonomous robot with intent-displaying HMI system.

FIG. 2 depicts a method flowchart for generating and displaying robot intent information.

FIG. 3 depicts an autonomous mobile robot equipped with HMI elements.

### DETAILED DESCRIPTION OF PREFERRED EMBODIMENTS

The following detailed description presents various embodiments of systems and methods for displaying robot intent information to enhance human-robot interaction safety and efficiency. While specific implementations are described, these should be understood as exemplary rather than limiting.

### I. System Architecture

### A. Overall System Configuration

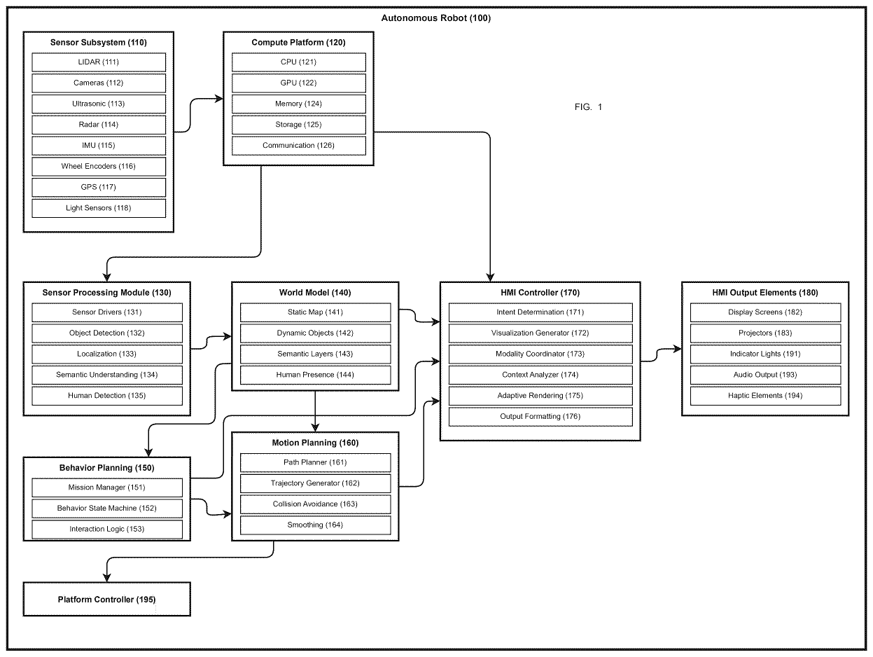

Referring to FIG. 1, an autonomous robot HMI system (100) according to one embodiment comprises several integrated subsystems:
Sensor Subsystem (110) provides environmental perception capabilities:—LIDAR Sensors (111): 2D or 3D laser scanning sensors for distance measurement and obstacle detection. May include rotating LIDAR for 360-degree coverage or solid-state LIDAR for compact integration.—Cameras (112): One or more cameras (monocular, stereo, RGB-D, 360-degree, etc.) for visual perception. Cameras may include fisheye lenses for wide field-of-view coverage.—Ultrasonic Sensors (113): For close-range obstacle detection (typically 0.1-5 meters).—Radar (114): For all-weather detection and velocity measurement.—IMU (115): Inertial Measurement Unit providing acceleration and angular velocity data for robot motion estimation.—Wheel Encoders (116): Measuring wheel rotation for odometry.—GPS/GNSS (117): For outdoor localization.—Light Sensors (118): Measuring ambient illumination for HMI brightness adaptation.
Compute Platform (120) processes sensor data and executes planning and control algorithms:—CPU (121): General-purpose processor(s) for sequential computation.—GPU (122): Graphics processing unit(s) for parallel processing, computer vision, and graphics rendering.—Memory (124): RAM for active data storage (typically 8-64 GB).—Storage (125): Non-volatile storage (SSD, flash) for maps, software, logs (typically 128 GB-2 TB).—Communication Interfaces (126): Ethernet, WiFi, cellular, CAN bus, etc.
Sensor Processing and Perception Module (130):—Sensor Drivers (131): Interface with raw sensor hardware, performing calibration, synchronization, and data formatting.—Object Detection and Tracking (132): Identifies and tracks dynamic objects in the environment (humans, vehicles, other robots, moving obstacles). May use computer vision algorithms (e.g., YOLO, Faster R-CNN for camera-based detection) and/or LIDAR-based detection.—Localization and State Estimation (133): Determines robot position and orientation using SLAM (Simultaneous Localization and Mapping), map matching, GPS, or other techniques. Typically fuses multiple sensor inputs using Kalman filtering or particle filtering.—Semantic Understanding (134): Classifies environmental elements (floors, walls, aisles, doors, equipment, etc.) and understands semantic properties.—Human Detection (135): Specifically identifies humans using appearance-based (camera) and/or geometry-based (LIDAR) detection. May include pose estimation to determine human facing direction and posture.
World Model (140) maintains a unified representation of the environment:—Static Map (141): Pre-built map of the environment or map generated through SLAM.—Dynamic Objects (142): Tracked moving objects with estimated positions, velocities, and predicted trajectories.—Semantic Layers (143): Higher-level environmental understanding (traffic zones, restricted areas, pedestrian pathways, vehicle lanes, etc.).—Human Presence Database (144): Specific tracking of detected humans with attributes including position, velocity, trajectory, facing direction, and estimated attention state.
Behavior Planning Module (150) determines high-level robot actions:—Mission Manager (151): Handles task assignment, mission sequencing, and high-level goals.—Behavior State Machine (152): Manages robot operating modes (idle, navigating, loading, waiting, error, emergency stop, etc.).—Interaction Logic (153): Makes decisions about interactions with humans and other agents, including yielding, requesting passage, waiting, etc.
Motion Planning Module (160) generates specific trajectories:—Path Planner (161): Computes geometric paths from current position to goal, avoiding obstacles. May use algorithms such as A*, RRT, or optimization-based planning.—Trajectory Generator (162): Adds velocity and acceleration profiles to paths, creating time-parameterized trajectories.—Collision Avoidance (163): Ensures trajectories maintain safe clearances from obstacles and humans, implements dynamic obstacle avoidance.—Smoothing and Optimization (164): Refines trajectories for comfort, efficiency, and adherence to vehicle constraints.
HMI Controller (170) manages intent communication:—Intent Determination (171): Analyzes robot state, planned trajectory, and environment to identify information that should be communicated to humans. Determines priority and urgency of messages.—Visualization Generator (172): Creates graphical representations of intents including arrows, paths, zones, symbols, and text. Renders these as vector graphics, raster images, or light patterns depending on output device.—Context Analyzer (174): Assesses contextual factors including robot speed, proximity to humans, ambient lighting, floor surface properties, and urgency level.—Adaptive Rendering (175): Modifies visualization parameters (size, brightness, color, detail level, animation style) based on context to optimize visibility and comprehension.—Modality Coordinator (173): Synchronizes multiple HMI output channels (visual, auditory, haptic) for consistent, reinforced communication.—Output Formatting (176): Converts high-level visualizations into device-specific command formats (pixel arrays for displays, PWM signals for lights, vector commands for projectors, audio signals for speakers).
HMI Output Elements (180) present intent information:—Display Screens (182): LCD, OLED, LED matrix, or e-paper displays showing graphical information, text, symbols, and animations. May be positioned on multiple faces of robot for omnidirectional visibility.—Indicator Lights (191): Individual LEDs, programmable LED arrays, individually addressable LED strips, light bars, or illuminated panels. May include traditional static lights with simple patterns, or advanced programmable systems enabling dynamic animations, color gradients, motion effects, and complex visual sequences for highly expressive intent communication.—Projectors (183): Project visual information onto environmental surfaces. Technologies may include DLP projectors, laser projectors, galvanometer-based laser scanners, or LED array projectors.—Audio Output (193): Speakers, buzzers, or voice synthesis for auditory alerts and messages.—Haptic Elements (194): For robots with physical contact points with humans (e.g., handlebars, handles), vibration or force feedback.
Platform Controller (195) executes motion commands:—Motor controllers, steering controllers, brake systems, power management, safety interlocks.

Communication between subsystems typically occurs over high-bandwidth networks (Ethernet-based, e.g., 1 Gbps or 10 Gbps) with real-time or near-real-time data exchange. Control loops typically operate at rates from 10 Hz (high-level planning) to 100+ Hz (low-level control).

### B. HMI Element Configuration

### Display Screens (182):

In one embodiment, the robot includes one or more display screens positioned to communicate with traffic users.

Display characteristics:—Size: Typically 7-15 inch diagonal for mobile robots, larger for vehicles—Resolution: Configured to enable clear symbol and text rendering (e.g., 800×480 to 1920×1080 pixels)—Brightness: High brightness (500-2000 nits) for outdoor visibility—Refresh Rate: 30-60 Hz for most applications—Viewing Angle: Wide viewing angle (>170 degrees) for visibility from various approach angles

Displays may show various types of information including:—Directional indicators showing intended travel direction—Destination information (e.g., aisle identifiers such as “B-26”, bay numbers, dock locations, zone designations) indicating where robot is traveling, analogous to bus/train destination displays, enabling traffic users to determine if robot's path intersects their work area—Status information (operational mode, activity state, maneuver intent, etc.)—Animated graphics showing path trajectories—Warning symbols or alerts—Robot identification and mission information

### Indicator Lights (191):

Indicator lights range from traditional vehicle-like systems to advanced programmable LED systems:
Traditional Indicator Lights:—Turn Signals: Amber lights on left and right sides flashing to indicate turning intentions—Brake Lights: Red lights activating during deceleration—Status Lights: Green/yellow/red lights indicating operational status—Directional Headlights: Forward-facing lights that may illuminate brighter in the direction of intended travel
Advanced Programmable LED Systems:—Individually Addressable LED Strips: LED strips (e.g., WS2812, APA102, SK6812) where each LED can be independently controlled for color, brightness, and timing—Programmable LED Arrays: Multi-dimensional arrays enabling complex visual patterns, animations, and effects—Dynamic Animation Capabilities: Flowing patterns, color waves, directional sweeps, proximity-responsive gradients, velocity-proportional animations—Expressive Visual Effects: Chase sequences, breathing patterns, ripple effects, theater-style marquee animations, color transitions synchronized to robot state
Light characteristics:—Color: Standard semantic colors (red=stop/danger, yellow/amber=caution/turning, green=go/safe, blue=special states), or programmable full RGB color control for custom intent signaling—Brightness: Configured to provide daylight visibility (typically 100-1000 lumens total output), with per-pixel brightness control for advanced systems—Pattern Complexity: From simple flash patterns (steady, slow flash, fast flash, alternating) to complex programmed animations including directional motion effects, gradient transitions, and context-responsive dynamic sequences—Update Rate: Traditional systems 1-5 Hz, programmable systems 30-120 Hz for smooth animations

### Projection Systems (183):

Projection systems project graphics onto environmental surfaces (typically ground/floor):
DLP Projectors: Digital Light Processing projectors using LED or laser light sources. Advantages: full-color raster graphics, mature technology. Disadvantages: relatively large/heavy, moderate brightness.
Laser Line Projectors: Simple systems projecting line patterns (crosshairs, boxes, etc.) using fixed optics. Advantages: very compact, low cost. Disadvantages: limited to simple fixed patterns.
Galvo Laser Scanners: Galvanometer-based laser scanning systems (described in related patent application 6138-0017P). Advantages: high brightness, vector graphics, fast animation, cost-effective. Disadvantages: custom packaging and software development requirements.

Projected content may include:—Forward path trajectory showing where robot will travel—Turn indicators showing arc of intended turn—Safety zones with visual demarcation around robot—Warning symbols or alerts projected near hazards—Directional indicators—Status or intent messages

### II. Intent Determination and Visualization Generation

### A. Intent Determination Process

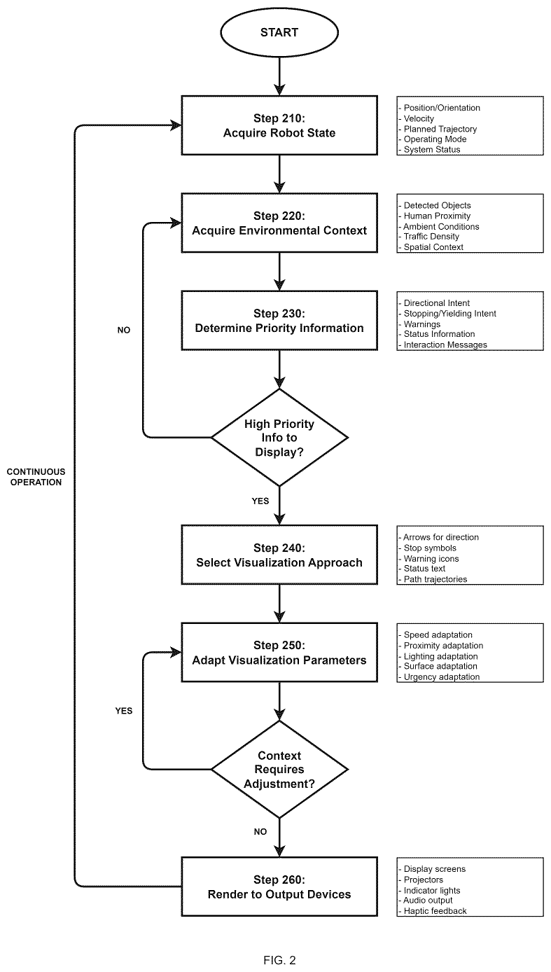

Referring to FIG. 2, the HMI controller determines what information to communicate based on robot state and environment:

### Step 210: Acquire Robot State

The HMI controller retrieves current robot state information:—Position and Orientation: Current robot pose (x, y, θ) in world coordinates—Velocity: Current linear and angular velocities—Planned Trajectory: Future path from motion planner, typically 3-10 seconds into the future—Operating Mode: Current behavioral state (navigating, idle, loading, waiting, emergency stop, etc.)—Mission Context: Current task, destination, priority—System Status: Battery level, error conditions, component health

### Step 220: Acquire Environmental Context

Detected Objects: Positions and classifications of obstacles, vehicles, humans
Human Proximity: Distances and directions to nearest humans
Ambient Conditions: Lighting level, floor surface characteristics, weather (if outdoors)
Traffic Density: Number of nearby humans and vehicles, congestion level
Spatial Context: Current location type (narrow aisle, open area, intersection, etc.)

### Step 230: Determine Priority Information

The intent determination module (171) analyzes robot state and context to identify high-priority information to communicate:
Directional Intent (High Priority if robot is moving):—If robot velocity>threshold (e.g., 0.1 m/s), communicate intended direction—If turn is planned within next N seconds (e.g., 3-5 s), communicate turning intention—If path includes complex maneuvers, communicate trajectory
Stopping/Yielding Intent (High Priority if decelerating or blocked):—If robot is decelerating, communicate stopping intention—If robot has stopped to yield to human or obstacle, communicate yielding status—If robot is waiting for condition to clear, communicate waiting status
Warnings (Highest Priority):—If human detected in danger zone around robot, display prominent warning—If robot is carrying elevated load or wide load, display hazard warning—If system error or degraded operation, display caution indicator—If emergency stop activated, display emergency status
Status Information (Lower Priority, displayed when idle or low activity):—Operating mode, battery level, mission progress, robot ID
Interaction Messages (Context-Dependent):—Request for passage if robot needs to pass stationary obstacle—Yielding acknowledgment if robot is yielding right-of-way—Activity status during material handling operations—Hazard warnings during hazardous operations

Priority ranking ensures that critical safety information is always displayed, while less critical information may be suppressed in high-workload situations.

### Step 240: Select Visualization Approach

For each piece of information to communicate, the visualization generator (172) determines visual representations based on the type of intent information:
For Directional Intent:—Visual representations indicating intended direction of travel, which may be static or animated to convey motion—Spatial path representations showing planned trajectory through the environment—Motion indicators conveying direction and flow of intended movement
For Stopping/Yielding:—Visual indications of deceleration or stopping intent—Communication of stationary yielding state—Signals indicating that traffic users may proceed safely
For Warnings:—Visual alerts drawing attention to detected hazards or dangerous conditions—Spatial demarcation of hazard zones or restricted areas—Urgency-indicating patterns or effects for time-critical warnings
For Status:—Operational state indicators—System condition information—Context-relevant status communication
Selection criteria:—Comprehensibility: Visual representations enable rapid understanding by traffic users—Clarity: Ensure intent information is unambiguous—Context-Appropriateness: Adapt representation style to operating environment and user expectations

### B. Context-Adaptive Rendering

### Step 250: Adapt Visualization Parameters

The adaptive rendering module (175) adjusts visualization parameters based on contextual factors:

### Speed-Based Adaptation:

Robot speed affects visualization scale and positioning through continuous dynamic scaling relationships:

The system dynamically adjusts visualization parameters as continuous functions of robot velocity, providing smooth transitions and proportional adaptation across the full range of operating speeds. As velocity increases, the system continuously increases projection distance, element size, and decreases detail level.

### Example Embodiment

// Continuous scaling functions relating velocity to visualization parameters

| | |
|---|---|
| projection_distance = f1 (velocity) | // Monotonically increasing function |
| element_size = f2(velocity) | // Monotonically increasing function |
| detail_level = f3(velocity) | // Monotonically decreasing function |

Where these functions may be implemented as:
Linear relationships: projection_distance=base_distance+k1*velocity
Power relationships: element_size=base_size*(1+velocity)\hat{ }k2
Sigmoid relationships: detail_level=max_detail/(1+exp(k3*velocity))
Piecewise linear or polynomial functions providing smooth continuous scaling
   Example parameter values at representative velocities:
At low velocity (e.g., ~0.2 m/s):
   projection_distance≈shorter distance, element_size≈smaller, detail_level≈HIGH
At moderate velocity (e.g., ~1.0 m/s):
   projection_distance≈intermediate distance, element_size≈intermediate, detail_level≈MEDIUM
At higher velocity (e.g., ~2.0 m/s):
   projection_distance≈farther distance, element_size≈larger, detail_level≈LOW

Rationale: Continuous velocity-based scaling provides smooth, proportional adaptation without discrete transitions. Faster speeds require earlier warning (farther projection), larger graphics for visibility at greater distance, and simplified information to avoid cognitive overload. Slower speeds allow detailed information as humans have more time to process.

### Proximity-Based Adaptation:

Distance to nearest detected human affects detail, brightness, and color profile through continuous dynamic adaptation:

The system dynamically adjusts visualization parameters as continuous functions of human proximity distance, providing smooth transitions across the full range of distances. As human proximity increases (distance decreases), the system continuously increases brightness and detail level, and transitions color profile along a spectrum.

### Example Embodiment

// Continuous scaling functions relating human distance to visualization
parameters

| | |
|---|---|
| brightness = g1(nearest_human_distance) | // Monotonically decreasing |

function (closer = brighter)

| | |
|---|---|
| detail_level = g2(nearest_human_distance) | // Monotonically decreasing |

function (closer = more detail)

| | |
|---|---|
| color_profile = g3(nearest_human_distance) | // Continuous color transition |

function

| | |
|---|---|
| directed_projection = g4(nearest_human_distance) | // Activation function |

Where these functions may be implemented as:
Inverse relationships: brightness=base_brightness+k1/(nearest_human_distance+offset)
Exponential decay: detail_level=max_detail*exp(−k2*nearest_human_distance)
Color mapping: color_profile=map_distance_to_color_spectrum(nearest_human_distance, green_to_red_spectrum)
Sigmoid activation: directed_projection=sigmoid(k3*(threshold nearest_human_distance))
Piecewise linear or polynomial functions providing smooth continuous adaptation
   Example parameter values at representative distances:
At farther distance (e.g., ~10 m):
   brightness≈moderate, detail_level≈LOW, color_profile≈green tones, directed_projection≈inactive
At intermediate distance (e.g., ~5 m):
   brightness≈high, detail_level≈MEDIUM, color_profile≈amber/yellow tones, directed_projection≈active
At closer distance (e.g., ~2 m):
   brightness≈very high, detail_level≈HIGH, color_profile≈red tones, directed_projection≈active

### Color Transition Based on Human Proximity:

The system dynamically adjusts the color profile of HMI elements (displays, projected graphics, indicator lights) based on proximity to detected humans through continuous color spectrum transitions:
Green tones: Humans at safe distance (no immediate interaction risk)—conveys “normal operation, safe”
Amber/Yellow tones: Humans at moderate proximity (caution warranted)—conveys “be aware, coordination may be needed”
Red tones: Humans at close proximity (high interaction likelihood or danger zone)—conveys “warning, maintain clearance”

The color profile transitions continuously along the green-yellow-red spectrum as a function of decreasing distance, providing gradual and proportional visual feedback to both the detected human and other observers about interaction risk level without discrete steps.

Rationale: Continuous proximity-based adaptation provides smooth, proportional response to changing human-robot distances. Distant humans need basic awareness of robot presence and general direction. Nearby humans need detailed information for precise coordination. Continuous color-coding provides immediate, intuitive understanding of safety status without requiring interpretation of text or complex graphics.

### Lighting-Based Adaptation:

Ambient lighting affects display brightness and contrast through continuous dynamic adaptation:

The system dynamically adjusts HMI output parameters as continuous functions of measured ambient illumination level, providing smooth transitions across the full range of lighting conditions. As ambient lighting increases, the system continuously increases display brightness, projection power, and contrast enhancement to maintain visibility.

### Example Embodiment

ambient_lux = measure_ambient_light( )
// Continuous scaling functions relating ambient illumination to output
parameters

| | |
|---|---|
| display_brightness = h1(ambient_lux) | // Monotonically increasing |

function

| | |
|---|---|
| projection_power = h2(ambient_lux) | // Monotonically increasing |

function

| | |
|---|---|
| contrast_enhancement = h3(ambient_lux) | // Monotonically increasing |

function

Where these functions may be implemented as:
Linear relationships: display_brightness=min_brightness+k1*ambient_lux
Logarithmic relationships: projection_power=base_power+k2*log(ambient_lux+1)
Piecewise linear functions with saturation: contrast_enhancement=min(max_contrast, k3*ambient_lux)
Sigmoid or tanh functions providing smooth saturation at extremes
Lookup tables with interpolation for empirically-determined optimal mappings
   Example parameter values at representative illumination levels:
At low illumination (e.g., ~50 lux-dark indoor):
   display_brightness≈30%, projection_power≈low, contrast_enhancement≈minimal
At moderate illumination (e.g., ~500 lux-typical indoor):
   display_brightness≈60%, projection_power≈medium, contrast_enhancement≈moderate
At high illumination (e.g., ~2000 lux-bright indoor/outdoor):
   display_brightness≈95%, projection_power≈high, contrast_enhancement≈maximum

Rationale: Continuous lighting-based adaptation provides smooth, proportional adjustment to varying ambient conditions without abrupt transitions. Bright ambient light requires higher HMI output to maintain visibility. Dark conditions allow lower output, reducing glare and power consumption while maintaining effective communication.

### Surface-Based Adaptation (for Projections):

Floor surface characteristics affect projection appearance through continuous dynamic adaptation:

The system dynamically adjusts projection parameters as continuous functions of measured or estimated surface properties, including reflectivity and color characteristics. As surface reflectivity decreases (darker surfaces), the system continuously increases projection power, and color selection is continuously optimized for contrast based on surface color properties.

### Example Embodiment

| | |
|---|---|
| surface_reflectivity = estimate_surface_reflectivity( ) | // Normalized 0.0 to 1.0 |
| surface_brightness = estimate_surface_brightness( ) | // Normalized 0.0 to |

1.0

| | |
|---|---|
| surface_color hue = estimate_surface_color_hue( ) | // Color space |

coordinate
// Continuous scaling functions relating surface properties to projection
parameters

| | |
|---|---|
| projection_power = p1 (surface_reflectivity) | // Monotonically |

decreasing function

| | |
|---|---|
| color_contrast_weight = p2(surface_brightness) | // Function for color |

optimization

| | |
|---|---|
| color_selection = p3(surface_color_hue, surface_brightness) | // Continuous |

color mapping

Where these functions may be implemented as:
Inverse relationships: projection_power=base_power/(surface_reflectivity+offset)
Quadratic or power relationships for non-linear reflectivity response
Continuous color contrast optimization using color space distance metrics
Perceptual contrast functions based on CIELAB or other color difference formulas
Adaptive color palette selection maximizing visibility across surface color spectrum
   Example parameter values at representative surface properties:
At high reflectivity surface (e.g., light concrete, reflectivity ~0.7):
   projection_power≈moderate, color_palette≈darker/saturated colors for contrast
At medium reflectivity surface (e.g., gray flooring, reflectivity ~0.4):
   projection_power≈moderately high, color_palette≈optimized for mid-tone contrast
At low reflectivity surface (e.g., dark epoxy, reflectivity ~0.1):
   projection_power≈high, color_palette≈bright colors (green, yellow, cyan) for contrast

Rationale: Continuous surface-based adaptation provides smooth, proportional adjustment to varying floor surface properties. Dark surfaces absorb more light, requiring higher projection power through inverse relationship with reflectivity. Color selection continuously optimizes contrast against surface color characteristics to maintain visibility across diverse surface types.

### Urgency-Based Adaptation:

Message urgency affects visual prominence through continuous dynamic adaptation:

The system computes urgency as a continuous metric representing the time-criticality and importance of the message, and dynamically adjusts visualization parameters as continuous functions of this urgency metric. As urgency increases, the system continuously increases brightness, flash rate, size, and audio volume, while transitioning color selection along a spectrum.

### Example Embodiment

// Compute urgency as continuous metric (normalized 0.0 to 1.0)
urgency = compute_urgency_metric(time_to_collision, hazard_severity,
interaction_likelihood)
// Continuous scaling functions relating urgency to visualization parameters
brightness = u1(urgency) // Monotonically increasing function
flash_rate = u2(urgency) // Monotonically increasing function (with
constraints)
size_multiplier = u3(urgency) // Monotonically increasing function
color_temperature = u4(urgency) // Continuous color mapping along
spectrum
audio_volume = u5(urgency) // Monotonically increasing function

Where these functions may be implemented as:
Linear relationships: brightness=base_brightness+k1*urgency
Exponential relationships: flash_rate=min_rate*exp(k2*urgency), constrained to avoid 5-30 Hz seizure range
Polynomial scaling: size_multiplier=1.0+k3*urgency\hat{ }2
Color spectrum mapping: color_temperature=map_urgency_to_color_spectrum(urgency, green_to_yellow_to_red)
Sigmoid functions: audio_volume=max_volume /(1+exp(−k4*(urgency−threshold)))
Piecewise linear or spline functions providing smooth continuous scaling
   Example parameter values at representative urgency levels:
At low urgency (e.g., urgency ~0.2—routine information):
   brightness≈normal, flash_rate≈slow/steady, size_multiplier≈1.0, color≈green/blue tones, audio≈none/quiet
At moderate urgency (e.g., urgency ~0.6—caution/warning):
   brightness≈high, flash_rate≈moderate (1-2 Hz), size_multiplier≈1.5, color≈yellow/amber tones, audio≈moderate
At high urgency (e.g., urgency ~0.95—critical/emergency):
   brightness≈maximum, flash_rate≈fast (3-5 Hz), size_multiplier≈2.0, color≈red tones, audio≈loud

Rationale: Continuous urgency-based adaptation provides smooth, proportional response to varying message criticality. Computing urgency as a continuous metric based on situational factors (time-to-collision, hazard severity, likelihood) enables nuanced, graduated communication rather than abrupt transitions. Higher urgency messages require greater visual and auditory prominence to ensure rapid human attention and response.

### III. Detailed Description of Embodiments

### A. Projection-Based Intent Display

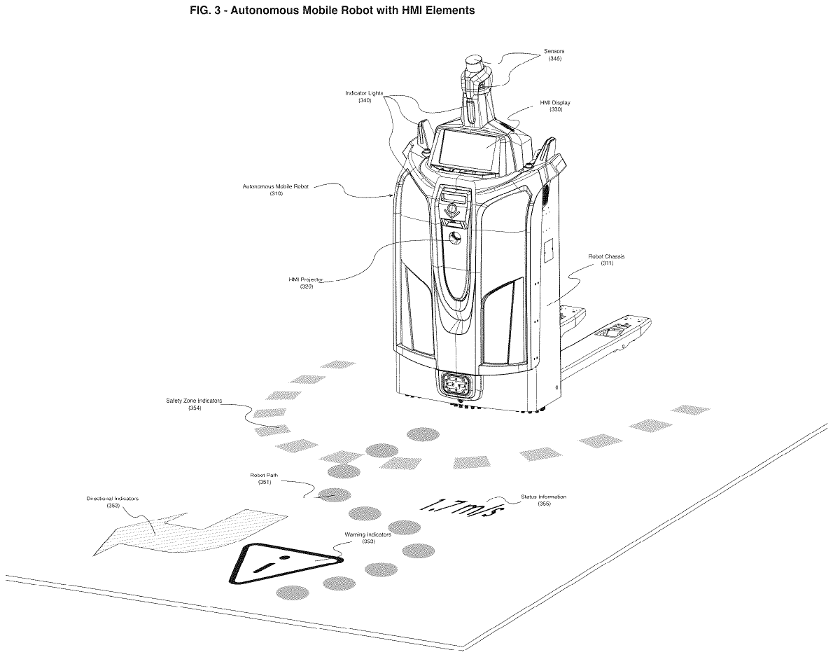

Referring to FIG. 3, one embodiment features projection of intent information onto ground surfaces:

An autonomous mobile robot (310) (e.g., AMR, automated forklift, delivery robot) includes:
Robot Chassis (311): Main body housing drive system, compute platform, sensors, and payload area
HMI Projector (320): Projection system mounted on robot, aimed downward at 30-60 degree angle from horizontal
HMI Display (330): Display screen on robot front/rear showing status and intent
Indicator Lights (340): Turn signals, status lights, brake lights
Sensors (345): Cameras, LIDAR, etc. for perception

The HMI projector (320) projects various types of graphics onto the ground to communicate robot intent. In one embodiment, projected elements may include:
Robot Path (351):—Visual representation of the robot's intended path over a future time period (e.g., next 3-5 seconds)—Path representation originates at robot's current position and extends along planned trajectory—Path curves or bends to show turning paths—May be color-coded based on robot state or proximity to detected humans—May include animated elements to convey direction and flow of motion
Directional Indicators (352):—Visual elements pointing in the intended direction of travel, including turn signals and directional arrows—Positioned ahead of robot at distances adapted to robot speed—For turning maneuvers, may be projected ahead of robot and along intended turn path—May include temporal dynamics (pulsing, flashing, color changes) to attract attention and draw focus to turning intent—Color or appearance may dynamically shift based on robot state or proximity to detected humans
Warning Indicators (353):—Visual alerts projected near detected hazards to communicate warnings—May include symbolic representations, text messages, or graphical elements—Examples may include human detection warnings, overhead hazard warnings, or general hazard alerts
Safety Zone Indicators (354):—Visual demarcation of zones around robot perimeter—May use color coding to indicate different safety or clearance zones—May include text or symbolic information about zone meaning—Zones may expand/contract based on robot speed—Zone appearance may dynamically adjust based on proximity to detected humans
Status Information (355):—Text or graphical indicators displaying robot operational status and mission information—May include destination identifier (e.g., aisle location, bay number, dock identifier) enabling traffic users to understand where robot is traveling—May include battery level, speed, robot identification, operational mode, or other relevant information—Destination display analogous to bus/train destination signage, helping humans determine if robot's path will intersect their location

### Operational Example:

In one embodiment, an autonomous robot (310) traveling through a warehouse aisle demonstrates adaptive intent visualization:
Straight-Line Travel: Robot projects path representation ahead, directional indicators, and safety zone demarcation adapted to current speed
Approaching Intersection: Robot's path planner determines it will turn right at upcoming intersection
   I. At distance before intersection: Begin projecting turn indication
   II. Progressively closer: Increase prominence of turn indication, activate turn signal lights
   III. Near turn point: Project full turn trajectory onto ground through the turn
   IV. During turn: Maintain turn signals and trajectory visualization
   V. After completing turn: Transition back to straight-line path visualization
Human Detected: Robot's perception system detects human worker crossing path ahead
   I. Project warning indication alerting to detected human
   II. Increase safety zone size
   III. Begin deceleration (reflected in adaptive changes to projected visualizations)
   IV. If robot stops to yield: Communicate yielding state and that human may proceed
   V. After human clears: Communicate resumption of motion and resume path visualization

### Projection System Characteristics:

Technology: Projection systems configured to project visual information onto environmental surfaces, including DLP projectors, laser projectors, or galvanometer-based laser scanning systems
Luminous Output: Brightness configured to provide visibility under operating environment lighting conditions, ranging from low-light indoor environments to high-ambient-light conditions
Resolution: Configured to enable clear rendering of graphical elements, symbols, and text at projection distances appropriate for communication with traffic users
Projection Range: Adapted to robot velocity, communication timing requirements, and distances enabling adequate perception and response by traffic users
Coverage Area: Image size configured to communicate intent information within field of view of traffic users and provide spatially-appropriate visualization
Temporal Performance: Update rate configured to provide smooth animation, temporal dynamics, and responsive visualization updates
Environmental Robustness: Configured to maintain visibility and effectiveness across range of ambient lighting conditions encountered in operating environment

### B. Display-Based Intent Signaling

When using display screens to communicate intent, the system presents dynamically-generated content based on robot state with continuous adaptation of display characteristics:

### Display Content Characteristics:

Display content is continuously adapted based on robot state, environmental context, and communication requirements. Content characteristics include:
Visual complexity: Ranges from simple symbolic representations to detailed graphical visualizations, adapted to viewing time, distance, and urgency
Textual information: Alphanumeric content with length and detail level adapted to communication requirements and viewing conditions
Motion and animation: Temporal dynamics adapted to attention requirements, urgency level, and seizure-safe constraints
Color mapping: Continuous color selection and background coloring based on state urgency, proximity to humans, and semantic meaning
Information density: Amount and detail of displayed information adapted to robot velocity, proximity to traffic users, and message priority

### Continuous Content Adaptation:

Displays update continuously with content and presentation dynamically adjusted based on situational factors:

### Example Embodiment

Update cycle (operating at rate configured for responsiveness):
robot_state=get_robot_state( ) // Continuous state representation
planned_trajectory=get_planned_path( )
nearby_humans=detect_humans( )
urgency=compute_urgency_metric(robot_state, environment)

```
// Continuous functions mapping state to display characteristics
visual_complexity = d1(robot_state, urgency, viewing_conditions)
information_density = d2(velocity, proximity_to_humans, urgency)
animation_intensity = d3(urgency, attention_requirements)
color_mapping = d4(urgency, proximity_to_humans, robot_state)
text_verbosity = d5(velocity, display_time_available, urgency)
// Generate display content with continuously-adapted parameters
display_content = generate_adaptive_display(
  intent_information = extract_intent(robot_state, planned_trajectory),
  visual_parameters = {
    complexity: visual_complexity,
    density: information_density,
    animation: animation_intensity,
    color: color_mapping,
    text_detail: text_verbosity
  }
)
render_to_display(display_content)
```

Where adaptation functions may implement continuous relationships such as increasing visual prominence as urgency increases, reducing information density as velocity increases, or enhancing attention-drawing animations as proximity to humans decreases.

### C. Light-Based Intent Signaling

Light-based signaling ranges from traditional static indicators to advanced programmable LED systems:

### Traditional Indicator Lights:

Turn Signals:—Amber lights on left and right sides of robot—Flash at 1-2 Hz when turn is planned—Synchronized with display and projection turn indicators
Brake Lights:—Red lights on rear of robot—Activate during deceleration—Brightness proportional to deceleration rate (higher decel=brighter lights)
Status Lights:—Green: Normal autonomous operation—Yellow: Caution state (degraded sensors, low battery, manual mode)—Red: Error or emergency stop—Blue: Special modes (maintenance, calibration)
Directional Headlights:—Front-facing lights that can illuminate independently—When turning, increase brightness of light on turn-direction side—Creates visual cue pointing toward intended direction

### Advanced Programmable LED Systems:

Individually addressable LED strips and arrays enable highly expressive intent communication through dynamic animations:
Directional Motion Effects:—Sequential LED illumination creating “flowing” effect in direction of intended motion—Color waves sweeping across LED strips toward turn direction—Velocity-proportional animation speed (faster robot motion=faster LED animation)
Proximity-Responsive Patterns:—LED strips transition from green to amber to red as humans approach—Expanding/contracting color gradients indicating approach/departure—Pulsing patterns with intensity proportional to urgency or proximity
Intent-Synchronized Animations:—Chasing patterns around robot perimeter indicating omnidirectional awareness—Theater-style marquee animations directing attention to specific robot areas—Breathing patterns during waiting/yielding states—Ripple effects emanating from detection zones when humans detected
Multi-Segment Coordination:—Different LED strips on different robot surfaces can display coordinated animations—Turn signals implemented as flowing color waves instead of simple flashing—Braking shown as red wave propagating from front to rear—Emergency stops trigger rapid red flash cascade across all LED elements

### D. Photosensitive Seizure Prevention

To ensure safety for individuals with photosensitive epilepsy, the HMI controller (170) implements flash rate constraints. Animation frequencies are limited to exclude the range of 5-30 Hz, which is known to trigger photosensitive seizures in susceptible individuals. Specifically, flashing patterns between 15-20 Hz present the highest risk. The system restricts animated visual indicators to either slow informational rates below 5 Hz or smooth high-frequency rates above 30 Hz, in compliance with WCAG 2.1 Guideline 2.3 for seizure prevention.

### E. Synchronized Multi-Modal Intent Display

Effective intent communication often involves coordinating multiple HMI modalities:

### Example Scenario: Robot Preparing to Turn Right at Intersection

In one embodiment, temporally-phased multi-modal communication for a turning maneuver may proceed as follows:
Anticipatory Phase (before maneuver initiation):—Projection: Begin projecting turn indication at low prominence—Display: Communicate approaching maneuver—Lights: Maintain normal state—Audio: Silent or low-level notification
Notification Phase (approaching maneuver):—Projection: Increase turn indication prominence with temporal dynamics—Display: Communicate turn direction and intent—Lights: Activate directional turn signals with temporal patterns—Audio: Optional auditory notification
Execution Phase (during maneuver):—Projection: High-prominence trajectory visualization through the turn—Display: Reinforce turn direction indication—Lights: Continue turn signals with increased temporal frequency—Audio: Optional auditory reinforcement if humans in proximity
Completion Phase (after maneuver):—Projection: Transition to post-turn visualization state—Display: Return to standard operational status indication—Lights: Deactivate turn signals—Audio: Return to silent or ambient state
Synchronization Benefits:—Redundancy: Information conveyed through multiple channels—Attention: Multi-modal onset captures attention—Reinforcement: Consistent message across modalities enhances understanding—Accessibility: Serves users with different sensory capabilities

### Continuous Modality Coordination:

The system dynamically coordinates multiple HMI modalities with continuous activation and intensity control based on message urgency and environmental conditions:

### Example Embodiment

For each intent message:
urgency=compute_urgency_metric(message, robot_state, environment) environment=assess_environment( ) // noise_level, visibility, etc.

```
// Continuous functions mapping urgency and environment to modality
weights
  projection_weight = m1(urgency, environment.visibility, surface_quality)
  display_weight = m2(urgency, proximity_to_humans,
viewing_angle_availability)
  lights_weight = m3(urgency, ambient_brightness,
omnidirectional_visibility_need)
  audio_weight = m4(urgency, environment.noise_level,
proximity_to_humans)
```

Where these functions may be implemented as:
Monotonically increasing with urgency: higher urgency→higher weights
Inverse relationships with environmental interference: high noise→higher audio weight
Saturation functions ensuring weights remain in valid ranges
Multi-factor optimization balancing effectiveness, power, and user experience

```
  // Activate modalities with continuous intensity control
  activate_projection(intensity = projection_weight *
base_projection_intensity)
  activate_display(intensity = display_weight * base_display_intensity)
  activate_lights(intensity = lights_weight * base_light_intensity)
  activate_audio(volume = audio_weight * base_audio_volume)
  // Apply continuous environmental adaptation to each active modality
  adapt_brightness_to_lighting(continuous_function)
  adapt_volume_to_noise(continuous_function)
  adapt_projection_to_surface(continuous_function)
```

This continuous coordination approach enables smooth, proportional modality activation rather than binary on/off decisions, with each modality's contribution dynamically weighted based on urgency and environmental suitability.

### IV. Operational Examples and Applications

### A. Warehouse AMR Navigation

Scenario: Autonomous mobile robot navigating warehouse aisles carrying materials

### Intent Display Applications:

In one embodiment, intent visualization for warehouse AMR operations may include:

### Aisle Travel:

I. Project forward path visualization showing intended route
II. Display destination information (e.g., “B-26”, “DOCK 3”) enabling humans to understand if robot is traveling to their work area
III. Display operational mode and velocity information
IV. Enable humans at intersections to perceive robot path before robot arrives
V. Destination display helps traffic users determine relevance of robot's movement to their activities

### Intersection Approach:

I. When turning: Activate turn indication across multiple modalities in advance of turn
II. When proceeding straight: Communicate continuation of current path
III. Enable humans at intersection to understand robot intentions and coordinate movements

### Human Worker Interaction:

I. When human detected in path: Communicate detection, expand safety zone visualizations, adapt velocity
II. When stopping to yield: Communicate yielding state and that human may proceed
III. After human clears: Optionally communicate acknowledgment, then resume path visualization

### Loading/Unloading:

I. Upon arrival at destination: Communicate arrival status and indicate loading/unloading location
II. During material handling: Communicate operation in progress and safety zones around active components
III. Before departure: Communicate imminent departure and show intended departure path

### Multi-Robot Coordination:

I. In multi-robot environments: Each robot visualizes its path, creating collective traffic flow visualization
II. At constrained passages: Yielding robot communicates yielding state, passing robot communicates passage
III. Enable humans to observe and understand robot-robot coordination
Benefits:—Reduced human-robot conflicts—Faster human decision-making (clear robot intentions)—Increased human confidence working near robots—Improved traffic flow efficiency

### B. Autonomous Forklift Operations

Example Scenario: Autonomous forklift transporting pallets in warehouse

In one embodiment, intent displays for forklift operations may include:

### Elevated Load Warning:

I. When carrying elevated load: Communicate overhead hazard and spatial extent of load
II. Expand warning visualization range to provide advance notice
III. Activate appropriate warning indicators

### Fork Positioning:

I. When approaching pallet for pickup: Project visual guides showing intended positioning
II. Communicate precision maneuvering intent to nearby humans

### Stability Warnings:

I. If carrying unstable or overweight load: Communicate load condition and expanded clearance requirements
II. Adapt visualization parameters to reflect speed limitations

### Blind Spot Communication:

I. Communicate limited visibility conditions in directions where perception is degraded
II. Project warnings indicating areas where humans should maintain increased clearance

### V. Advanced Embodiments

### A. Human-Aware Adaptive Display

In advanced embodiments, the system uses detailed human detection and pose estimation to optimize displays:

### Human Pose Estimation:

Computer vision algorithms analyze camera images to estimate:—Human position (x, y, z)—Facing direction (which way human is oriented)—Head pose (which direction human is looking)—Posture (standing, sitting, walking, running)—Attention state (looking at robot vs. looking away)

### Continuous Attention-Based Adaptation:

The system computes continuous attention metrics for detected humans and dynamically adapts HMI output based on estimated attention levels:

### Example Embodiment

For each detected human:

```
  // Compute continuous attention metric (0.0 = unaware, 1.0 = fully
attentive)
  attention_level = estimate_attention_metric(
    head_pose, gaze_direction, body_orientation,
    distance, movement_pattern, interaction_history
  )
  // Continuous functions mapping attention to display parameters
  prominence = a1(attention_level) // Monotonically decreasing
  detail_level = a2(attention_level) // Monotonically increasing
  attention_drawing = a3(attention_level) // Monotonically decreasing
  audio_likelihood = a4(attention_level, distance, urgency)
```

Where these functions may be implemented as:
Low attention (≈0.0-0.3): High prominence, attention-drawing features, potential audio
Moderate attention (≈0.3-0.7): Balanced prominence, increasing detail as attention grows
High attention (≈0.7-1.0): Lower prominence to avoid distraction, maximum detail
Inverse relationships: Lower attention→higher attention-drawing intensity
Saturation functions preventing excessive or insufficient signaling

// Apply continuously-adapted parameters
adapt_display_prominence(prominence)
adapt_information_detail(detail_level)
adapt_attention_drawing_features(attention_drawing)
conditionally_trigger_audio(audio_likelihood)

### Continuous Directional Projection Weighting:

When using projection systems, the system continuously weights projection direction and intensity based on human positions and interaction likelihood:

### Example Embodiment

humans_detected=detect_all_humans( )
   For each human in humans_detected:

```
  // Compute continuous projection weighting factors
  distance_weight = w1(distance_to_human) // Inverse relationship
  interaction_risk = w2(trajectory_intersection) // Collision likelihood
  attention_need = w3(human_attention_level) // Lower attention →
higher need
  projection_weight[human] = combine_weights(
    distance_weight, interaction_risk, attention_need
  )
// Direct projection toward highest-weighted humans or weighted centroid
projection_target = compute_weighted_projection_target(
  humans_detected, projection_weight
)
project_intent_at(projection_target, intensity = max(projection_weight))
// Adapt message content based on interaction context
message_context = assess_interaction_context(robot_state,
human_trajectories)
adapt_message_content(message_context) // Yielding, warning, status, etc.
```

### Continuous Multi-Human Adaptation:

When multiple humans are detected, the system continuously adapts visualization strategy based on human density and spatial distribution:

### Example Embodiment

humans=detect_all_humans( )
human_count=count(humans)
spatial_distribution=analyze_spatial_distribution(humans)

// Continuous functions mapping human density to visualization strategy
specificity_level = s1(human_count, spatial_distribution)
detail_granularity = s2(human_count, cognitive_load_estimate)
personalization_degree = s3(human_count, interaction_likelihood)

Where these functions may implement:
Low density (few humans): High specificity, detailed personalized information
Moderate density: Balanced approach with group-oriented visualization
High density (crowded): Simplified, general messaging to avoid information overload
Smooth transitions across density ranges without discrete thresholds
Spatial distribution factors: clustered vs. dispersed affects strategy

```
// Apply continuously-adapted multi-human visualization
generate_visualization(
  specificity = specificity_level,
  detail = detail_granularity,
  personalization = personalization_degree,
  target_audience = prioritize_humans_by_interaction_risk(humans)
)
```

### B. Learning and Optimization

Advanced systems may learn optimal display parameters from experience:

### Effectiveness Monitoring:

Track human responses to intent displays:

For each intent display event:
record(context, display_parameters, human_response)
context={robot_speed, display_type, urgency, lighting, human_distance}
display_parameters={size, brightness, color, animation}
human_response={response_time, appropriate_action, misunderstanding}
   Store in database for analysis

### Continuous Human Response Assessment:

The system computes continuous effectiveness metrics to quantify the quality of human responses to intent displays:

### Example Embodiment

For each intent display interaction:

```
// Measure multiple continuous response quality dimensions
response_timing = compute_response_timing_metric(
  time_to_first_reaction,
  expected_reaction_time,
  urgency_level
) // 0.0 = delayed/no response, 1.0 = immediate appropriate response
response_accuracy = compute_response_accuracy_metric(
  human_trajectory_change,
  intended_coordination_behavior,
  spatial_deviation
) // 0.0 = inappropriate action, 1.0 = perfectly appropriate action
confidence_indicator = compute_confidence_metric(
  movement_hesitation,
  trajectory_smoothness,
  attention_duration,
  repeated_glances
) // 0.0 = uncertain/confused, 1.0 = confident understanding
safety_outcome = compute_safety_metric(
  achieved_clearance,
  collision_risk_reduction,
  interaction_smoothness
) // 0.0 = unsafe outcome, 1.0 = optimal safety
efficiency_metric = compute_efficiency_metric(
  interaction_delay,
  path_deviation_cost,
  coordination_overhead
) // 0.0 = inefficient interaction, 1.0 = optimal efficiency
// Combine dimensions into overall effectiveness score
overall_effectiveness = combine_response_metrics(
  response_timing,
  response_accuracy,
  confidence_indicator,
  safety_outcome,
  efficiency_metric,
  weights = determine_metric_weights(interaction_type, context)
) // Continuous score 0.0 to 1.0
```

Where metrics may be implemented using:
Time-normalized functions: response_timing=exp(−k*delay/expected_time)
Spatial accuracy measures: trajectory similarity metrics, clearance adequacy
Behavioral indicators: hesitation detection, attention patterns, movement smoothness
Multi-factor integration: weighted combinations, learned importance weights
Context-adaptive scoring: different interaction types emphasize different metrics

### Continuous Adaptive Parameter Tuning:

Use machine learning to optimize display parameters based on continuous effectiveness metrics:

### Example Embodiment

Training data: {context, display_parameters}→continuous_effectiveness_score
Model: Continuous regression model predicting effectiveness (0.0 to 1.0)
   Input features: robot state, environmental context, human characteristics, display parameters
   Output: Predicted overall effectiveness score
   May use neural networks, Gaussian processes, ensemble methods, or other regression techniques
      Continuous optimization loop:
For current interaction context:

```
    // Generate candidate parameter sets spanning continuous parameter
space
    candidate_parameters = sample_parameter_space(current_context,
exploration_strategy)
    // Predict effectiveness for each candidate using learned model
    For each candidate in candidate_parameters:
      predicted_effectiveness[candidate] = model.predict(current_context,
candidate)
    // Select parameters maximizing predicted effectiveness
    optimal_parameters = argmax(predicted_effectiveness)
    // Apply selected parameters with optional exploration
    if random( ) < exploration_rate:
      used_parameters = explore_nearby_parameters(optimal_parameters)
    else:
      used_parameters = optimal_parameters
      apply_display_parameters(used_parameters)
  After interaction completion:
    // Compute continuous effectiveness from multi-dimensional response
assessment
    observed_effectiveness = compute_overall_effectiveness(
      response_timing, response_accuracy, confidence_indicator,
      safety_outcome, efficiency_metric
    )
    // Update model with continuous feedback
    model.update(
      features = {current_context, used_parameters},
      target = observed_effectiveness,
      learning_rate = adaptive_lr(model_confidence)
    )
    // Adapt parameter search strategy based on learning progress
    adjust_exploration_strategy(model_performance_trend)
```

Where optimization may employ:
Gradient-based optimization in continuous parameter space
Bayesian optimization for sample-efficient exploration
Multi-objective optimization balancing effectiveness, safety, and efficiency
Transfer learning across similar contexts and environments
Ensemble models combining multiple prediction approaches

### Fleet-Wide Learning:

In multi-robot deployments:

Each robot uploads:
(context, display_parameters, effectiveness) tuples to central database
Central server:
   Aggregates data from all robots
   Trains global model on aggregate data
   Distributes updated model to all robots
Benefits:
   Rapid learning from fleet-wide experience
   Identification of optimal practices
   Consistent behavior across fleet

### C. Customization and Regulatory Compliance

### Facility-Specific Customization:

Different deployment sites may require customized HMI:
facility_config=load_facility_configuration( )
   colors=facility_config.preferred_colors // May match facility safety color scheme
   symbols=facility_config.symbol_library // Facility-specific symbols
   language=facility_config.language // Text in appropriate language
   brightness_limits=facility_config.brightness_range // May have limits on bright displays

### Regulatory Compliance:

Adapt to jurisdiction-specific requirements:

```
    jurisdiction = determine_jurisdiction( ) // Based on GPS or facility ID
If jurisdiction.requires_vehicle_turn_signals:
  enable_turn_signal_lights( )
  enforce_turn_signal_timing( ) // E.g., must activate 100 ft before turn
If jurisdiction.requires_brake_lights:
  enable_brake_lights( )
  enforce_brightness_standards( )
If jurisdiction.requires_horn:
  enable_audio_alerts( )
If jurisdiction.requires_backup_alarm:
  enable_backup_beeper( )
```

### Accessibility:

Ensure HMI is accessible to people with disabilities:

```
    For color-blind accessibility:
  supplement_color_with_patterns( ) // Don't rely solely on red/green
distinction
  use_text_labels_with_colors( )
For vision impairment:
  provide_audio_supplements( )
  use_very_high_contrast( )
For hearing impairment:
  ensure_visual_communication_is_comprehensive( )
  don't_rely_solely_on_audio( )
```

### VI. Implementation Considerations

### A. Computational Requirements

### Processing Load:

Intent display system requires:—Perception: Object detection, human detection, tracking (GPU-intensive, 5-20 fps)—Intent determination: Lightweight logic (CPU, <1% load)—Visualization generation: Graphics rendering (GPU, moderate load)—Adaptive rendering: Context analysis and parameter optimization (CPU, <5% load)
Total additional computational load: Moderate (can be handled by systems already running perception and planning)

### Latency Requirements:

End-to-end latency from trajectory planning to display update should be minimized:—Planning update→Intent determination: <50 ms—Intent determination→Visualization generation: <50 ms—Visualization generation→Display output: <50 ms—Total: <150 ms

This ensures displays reflect current intentions without perceptible lag.

### B. Power Management and Optimization

### HMI Power Characteristics:

Different HMI output devices have varying power consumption characteristics:—Display screens: Power consumption varies with screen technology, size, and brightness level—Indicator lights: Power consumption scales with number of elements, LED technology, and brightness—Projection systems: Power requirements depend on projection technology, brightness output, and duty cycle—Audio systems: Power varies with volume level and activation frequency

### Continuous Power Management:

For battery-powered robots, the system implements continuous power optimization based on battery state and operational requirements:

### Example Embodiment

// Continuous functions mapping battery level and context to power
allocation
battery_level = measure_battery_state( ) // Normalized 0.0 to 1.0
human_proximity = detect_nearest_human_distance( )
urgency = compute_urgency_metric(robot_state, environment)
// Continuous power allocation weights based on battery state
display_power_weight = pw1(battery_level, human_proximity, urgency)
projection_power_weight = pw2(battery_level, human_proximity, urgency)
lights_power_weight = pw3(battery_level, urgency)
audio_power_weight = pw4(battery_level, urgency)

Where these functions may implement:
High battery (≈0.7-1.0): Full power allocation to all modalities
Moderate battery (≈0.3-0.7): Gradual reduction prioritizing energy-efficient modalities
Low battery (≈0.0-0.3): Aggressive power conservation, urgency-driven allocation
Monotonically increasing with urgency: Critical messages override power constraints
Proximity-based activation: Higher allocation when humans nearby
Modality efficiency weighting: Favor lower-power modalities when battery constrained

```
// Apply continuous power allocation
allocate_display_power(display_power_weight * available_power_budget)
allocate_projection_power(projection_power_weight *
available_power_budget)
allocate_lights_power(lights_power_weight * available_power_budget)
allocate_audio_power(audio_power_weight * available_power_budget)
// Continuous brightness/intensity scaling within allocated power
For each active modality:
adjust_output_intensity(
  target_intensity = compute_required_intensity(context),
  power_constraint = allocated_power[modality],
  optimization_objective = balance_effectiveness_and_efficiency( )
)
```

This continuous approach enables smooth power management without discrete thresholds, optimizing HMI effectiveness while respecting battery constraints and prioritizing critical communications.

### C. Sensor Requirements

Effective intent display benefits from:
Essential Sensors:—Localization sensors (LIDAR, cameras, wheel encoders, IMU)—Obstacle detection sensors (LIDAR, cameras, ultrasonic)
Highly Beneficial Sensors:—Camera(s) for human detection and pose estimation—Light sensor for ambient brightness measurement
Optional Sensors:—Radar for velocity measurement—Thermal cameras for human detection in low light—Microphone array for audio feedback on human reactions

### VII. System Variations

### A. Minimal Configuration

Low-cost implementation for resource-constrained applications:
Components:—Single front-facing display (7-10 inch LCD)—Basic LED indicator lights (turn signals, status lights)—Simple HMI controller (CPU-based, rule-based logic)
Capabilities:—Display directional arrows and basic status text—Show turn signals via lights and display—Limited adaptation (speed-based sizing only)
Applications:—Low-speed indoor robots—Environments with trained users who understand simple signals

### B. Standard Configuration

Balanced performance for typical commercial deployments:
Components:—Display screen(s) for status and intent information—Full LED light array (turn signals, brake lights, status lights)—DLP projector for ground projection—Comprehensive HMI controller with adaptive rendering
Capabilities:—Omnidirectional intent communication via projection and lights—Projected paths and safety zones—Context-adaptive rendering (speed, proximity, lighting)—Human detection-based adaptation
Applications:—Warehouse AMRs—Manufacturing AGVs—Indoor service robots—Industrial autonomous forklifts

### C. Advanced Configuration

High-performance system for demanding applications:
Components:—High-brightness display screen(s)—Advanced LED arrays with animation capability—Multiple laser projectors (galvo-based) for 360-degree projection—Audio output (speakers, voice synthesis)—Advanced HMI controller with AI-based optimization
Capabilities:—Full 360-degree high-brightness communication via projection and lights—Complex animated projections—AI-optimized parameter selection—Multi-modal synchronized communication—Human pose estimation and attention modeling—Fleet-wide learning
Applications:—High-speed warehouse AMRs—Complex multi-robot warehouse systems—High-throughput manufacturing facilities—Large-scale distribution centers with heavy human-robot interaction

### Other Implementation Options

It should be understood that the example embodiments described above may be implemented in many different ways. In some instances, the various “data processors” may each be implemented by a physical or virtual general purpose computer having a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system. One or more central processor units are attached to the system bus and provide for the execution of computer instructions. Also attached to system bus are typically I/O device interfaces for connecting disks, memories, and various input and output devices. Network interface(s) allow connections to various other devices. One or more memories provide volatile and/or non-volatile storage for computer software instructions and data used to implement an embodiment. Disks or other mass storage provides non-volatile storage for computer software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

The above description included an explanation of several example embodiments. It should be understood that while a particular feature may have been disclosed with respect to only one of several embodiments, that particular feature may be combined with one or more other features of the other embodiments as may be desired and advantageous for any given or particular application. It is, of course, not possible to describe every conceivable combination of components or methodologies for purposes of describing the innovations herein, and one skill in the art may now, in light of the above description, recognize that many further combinations and permutations are possible. Also, to the extent that the terms “includes,” and “including” and variants thereof are used in either the detailed description or the claims, these terms are intended to be inclusive in a manner similar to the term “comprising”.

It also should be understood that the block and flow diagrams may include more or fewer elements, be arranged differently, or be represented differently. The computing devices, processors, controllers, firmware, software, routines, or instructions as described herein may also perform only certain selected actions and/or functions. Therefore, it will be appreciated that any such descriptions that designate one or more such components as providing only certain functions are merely for convenience.

When a series of steps has been described above with respect to the flow diagrams, the order of the steps may be modified in other implementations. In addition, the operations and steps may be performed by additional or other modules or entities, which may be combined or separated to form other modules or entities. For example, while a series of steps has been described with regard to certain figures, the order of the steps may be modified in other implementations consistent with the principles explained herein. Further, non-dependent steps may be performed in parallel. Further, disclosed implementations may not be limited to any specific combination of hardware.

No element, act, or instruction used herein should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

Accordingly, the subject matter covered by this patent is intended to embrace all such alterations, modifications, equivalents, and variations that fall within the spirit and scope of the claims that follow.

1. A system for displaying intended actions of an autonomous mobile robot to traffic users in a shared environment, comprising:
one or more processors executing navigation software that generates trajectory data representing a planned path of said autonomous mobile robot over a future time period;
one or more sensors configured to detect environmental conditions including at least one of: ambient lighting level, proximity of humans, or properties of surfaces in said shared environment;
one or more human-machine interface output devices including at least one device selected from the group consisting of: a display screen, indicator lights, and a projection system configured to project visual information onto environmental surfaces; and
a human-machine interface controller in communication with said one or more processors, said one or more sensors, and said one or more human-machine interface output devices, said human-machine interface controller configured to:
receive said trajectory data from said navigation software,
receive environmental context data from said one or more sensors,
generate intent visualization data representing said planned path, said intent visualization data including at least one of: directional indicators showing intended direction of travel, path trajectory representations showing spatial route, or safety zone graphics indicating clearance boundaries,
adapt parameters of said intent visualization data based on said environmental context data, said parameters including at least one of: size, brightness, level of detail, or animation characteristics, and
control said one or more human-machine interface output devices to present said intent visualization data in a manner visible to traffic users at distances enabling advance perception of robot intentions.

2. The system of claim 1, wherein said one or more human-machine interface output devices includes a projection system configured to project visual information onto a ground surface or floor surface in said shared environment,
and wherein said human-machine interface controller is configured to control said projection system to project at least one of:
a path trajectory line extending from said autonomous mobile robot along said planned path for a distance adapted to current robot velocity to enable advance perception by traffic users,
a directional arrow pointing in an intended direction of travel, said directional arrow having a size configured to provide visibility to traffic users at the projection distance,
safety zone boundaries surrounding said autonomous mobile robot with color-coded regions indicating danger zones, caution zones, or safe approach zones, or
warning symbols or text messages positioned at locations corresponding to detected hazards or important information.

3. The system of claim 1, wherein said adapting parameters comprises:
determining a current velocity of said autonomous mobile robot; and
dynamically scaling said intent visualization data based on said current velocity, wherein increases in said current velocity cause:
increases in projection distance from said autonomous mobile robot to provide earlier warning to traffic users,
increases in size of graphical elements to maintain visibility at increased projection distances, and
decreases in level of detail to reduce cognitive load at higher speeds.

4. The system of claim 1, wherein said one or more sensors includes a human detection sensor configured to detect and localize humans in said shared environment,
and wherein said human-machine interface controller is configured to:
receive human position data from said human detection sensor, determine a distance to a nearest detected human,
adapt said intent visualization data based on said distance to said nearest detected human, including adjusting at least one of: brightness of said intent visualization data, size of said intent visualization data, level of detail in said intent visualization data, or color profile of said intent visualization data, and
optionally direct projection of said intent visualization data toward a position of said nearest detected human.

5. The system of claim 1, wherein said one or more sensors includes an ambient light sensor,
and wherein said human-machine interface controller is configured to:
measure ambient illumination level using said ambient light sensor, and
dynamically adjust output brightness of said one or more human-machine interface output devices as a function of said ambient illumination level, wherein increases in said ambient illumination level cause increases in said output brightness to maintain visibility of said intent visualization data across varying lighting conditions.

6. The system of claim 1, wherein said human-machine interface controller is configured to simultaneously adapt said intent visualization data based on multiple contextual factors, including:
determining said parameters by combining at least two of: current velocity of said autonomous mobile robot, proximity to detected humans, and said ambient lighting level, such that said intent visualization data reflects composite adjustments responsive to current robot state and environmental conditions.

7. The system of claim 1, wherein said intent visualization data includes temporal dynamics, and wherein said human-machine interface controller is configured to:
generate time-varying changes to visual properties of said intent visualization data to convey at least one of: direction of motion, urgency level, transition between robot states, or attention-drawing emphasis; and
constrain temporal variation frequencies to exclude a range of 5-30 Hz to prevent photosensitive seizures, restricting temporal variations to either slow rates below 5 Hz or smooth rates above 30 Hz.

8. The system of claim 1, wherein said one or more human-machine interface output devices includes:
a projection system configured to project visual information onto environmental surfaces,
a plurality of indicator lights including at least turn signal lights and status lights, and
at least one display screen,
and wherein said human-machine interface controller is configured to coordinate said projection system, said indicator lights, and said at least one display screen to provide synchronized multi-modal intent communication.

9. The system of claim 1, wherein said navigation software includes a motion planning module that generates said trajectory data including velocity profile information,
and wherein said human-machine interface controller is configured to:
detect when said autonomous mobile robot is decelerating based on said velocity profile information and modify said intent visualization data to communicate stopping intent to traffic users, and
when said autonomous mobile robot comes to a complete stop to yield to a detected obstacle or human, modify said intent visualization data to communicate that said autonomous mobile robot is in a stationary yielding state and that traffic users may proceed.

10. The system of claim 1, wherein said human-machine interface controller is configured to:
assign priority levels to different types of intent information based on safety criticality, wherein safety-critical information related to warnings and hazards receives higher priority than operational status information; and
selectively display said intent information based on said assigned priority levels, displaying higher priority information prominently while suppressing lower priority information when multiple types of information compete for display resources.

11. The system of claim 4, wherein said adapting said intent visualization data based on said distance to said nearest detected human includes dynamically adjusting said color profile such that:
when said distance to said nearest detected human indicates safe separation, said color profile comprises green tones conveying normal operation;
when said distance to said nearest detected human indicates moderate proximity, said color profile transitions to amber or yellow tones conveying caution; and
when said distance to said nearest detected human indicates close proximity, said color profile transitions to red tones conveying warning.

12. The system of claim 1, wherein said one or more processors execute mission planning software that determines a destination location for said autonomous mobile robot,
and wherein said human-machine interface controller is configured to:
receive destination identifier data from said mission planning software, said destination identifier corresponding to a location in said shared environment; and
include said destination identifier in said intent visualization data for display to traffic users, enabling traffic users to determine whether said autonomous mobile robot is traveling to locations relevant to their activities.

13. A method for communicating intended actions of an autonomous mobile robot, comprising:
determining, by one or more processors of said autonomous mobile robot, a planned trajectory for said autonomous mobile robot representing intended motion over a future time period;
measuring, by one or more sensors, contextual factors including at least two of: current velocity of said autonomous mobile robot, proximity to detected humans in an environment, ambient lighting level, or operating mode of said autonomous mobile robot;
generating, by a human-machine interface controller, intent visualization data representing said planned trajectory, said intent visualization data including graphical representations of at least one of: intended direction of travel, spatial path, or safety clearances;
adapting, by said human-machine interface controller, visual parameters of said intent visualization data based on said measured contextual factors, said visual parameters including at least one of: size of graphical elements, brightness, projection distance from said autonomous mobile robot, level of detail, or animation characteristics; and
displaying, by one or more human-machine interface output devices controlled by said human-machine interface controller, said intent visualization data in a manner visible to humans and other traffic users in said environment.

14. The method of claim 13, wherein said adapting visual parameters comprises:
dynamically scaling said visual parameters based on said current velocity, wherein increases in said current velocity cause:
increases in projection distance from said autonomous mobile robot to provide earlier warning to traffic users,
increases in size of graphical elements to maintain visibility at increased projection distances, and
decreases in level of detail to reduce cognitive load at higher speeds.

15. The method of claim 13, further comprising:
detecting, by a perception subsystem, one or more humans in said environment and determining position information for each detected human;
determining a distance to a nearest detected human; and
when said distance to said nearest detected human is within close proximity enabling detailed communication:
increasing brightness of said intent visualization data,
increasing level of detail to include fine-grained path information and status details, and
directing display of said intent visualization data toward a position of said nearest detected human.

16. The method of claim 13, wherein said one or more human-machine interface output devices includes a projection system, and wherein said displaying comprises:
projecting, using said projection system, said intent visualization data onto a ground surface or floor surface in said environment to spatially communicate at least one of: said planned trajectory, intended direction of travel, safety clearances around said autonomous mobile robot, or warnings about detected hazards.

17. The method of claim 13, wherein said one or more human-machine interface output devices includes at least a projection system, indicator lights, and a display screen, and wherein said displaying comprises:
coordinating output across said projection system, said indicator lights, and said display screen to provide temporally-phased communication of intent information, wherein prominence of said intent visualization progressively increases as a planned maneuver approaches initiation and during execution.

18. The method of claim 13, further comprising:
monitoring effectiveness of said displayed intent visualization by analyzing responses of detected humans, said analyzing including detecting whether detected humans alter trajectory or behavior in response to displayed warnings or directional indicators;
recording effectiveness data associating contextual conditions, visual parameters, and observed human responses; and
adapting future visual parameters based on said effectiveness data to improve human comprehension.

19. A non-transitory computer-readable storage medium storing instructions that, when executed by one or more processors of an autonomous mobile robot, cause said one or more processors to perform operations comprising:
receiving trajectory data from a navigation module, said trajectory data representing a planned path of said autonomous mobile robot;
receiving sensor data including at least two of: robot velocity, detected human positions, ambient lighting level, or floor surface properties;
determining intent information to communicate based on said trajectory data and a current operating state of said autonomous mobile robot;
generating visual representations of said intent information including at least one of: directional arrows, path trajectories, safety zones, or warning symbols;
adapting visual parameters of said visual representations based on said sensor data, including adjusting at least one of: size, brightness, projection distance, or level of detail; and
transmitting output commands to one or more human-machine interface devices to display said visual representations.

20. The non-transitory computer-readable storage medium of claim 19, wherein said adapting visual parameters comprises:
dynamically scaling said visual parameters based on said robot velocity, wherein increases in said robot velocity cause:
increases in projection distance from said autonomous mobile robot to enable earlier perception by traffic users,
increases in size of graphical elements to maintain visibility at increased projection distances, and
decreases in level of detail to reduce cognitive load at higher speeds.

21. The non-transitory computer-readable storage medium of claim 19, wherein said operations further comprise:
detecting a human in a path of said autonomous mobile robot and modifying said visual representations to communicate presence of said detected human to traffic users; and
when said autonomous mobile robot stops to yield to said detected human, modifying said visual representations to communicate that said autonomous mobile robot is yielding and that said detected human may proceed.

22. The non-transitory computer-readable storage medium of claim 19, wherein said operations further comprise:
detecting when said autonomous mobile robot is carrying an elevated load based on sensor data from a load monitoring system; and
modifying said visual representations to communicate presence and spatial extent of said elevated load to traffic users.

23. The system of claim 1, wherein said human-machine interface controller is further configured to optimize said intent visualization data through continuous effectiveness assessment by:
computing continuous response metrics for detected humans interacting with said autonomous mobile robot, said continuous response metrics including at least two dimensions selected from: response timing quantifying reaction speed, response accuracy quantifying behavioral appropriateness, confidence level quantifying human understanding based on movement patterns, safety outcome quantifying achieved clearance, and interaction efficiency quantifying coordination overhead;
combining said continuous response metrics into an overall effectiveness score;
maintaining a predictive model relating contextual conditions and display parameters to expected effectiveness; and
adapting said parameters of said intent visualization data for future interactions by selecting parameters that optimize predicted effectiveness according to said predictive model, and updating said predictive model based on observed effectiveness scores to improve parameter selection over time.

24. The system of claim 1, wherein said human-machine interface controller is further configured to manage power consumption by:
measuring battery state of said autonomous mobile robot as a continuous metric;
computing continuous power allocation weights for each of said one or more human-machine interface output devices based on said battery state, proximity to detected humans, and urgency level, wherein said power allocation weights are:
monotonically increasing with urgency such that critical communications override power constraints, and
adapted based on proximity to detected humans to increase power allocation when humans are nearby;
allocating power to each of said one or more human-machine interface output devices proportionally to said computed power allocation weights; and
adjusting output intensity of each of said one or more human-machine interface output devices within allocated power constraints while balancing communication effectiveness and energy efficiency.
